(19) United States
(12) Patent Application Publication
(10) Pub. No.: US 2005/0047174 A1
(43) Pub. Date: Mar. 3, 2005

(54) Direct-light illuminating unit of LCD module

(76) Inventors: John Chungteh Pan, Taichung City (TW); Chih-Kuang Chang, Taichung City (TW)

Correspondence Address: BIRCH STEWART KOLASCH & BIRCH, PO BOX 747, FALLS CHURCH, VA, 22040-0747, US

(21) Appl. No.: 10/651,037

(22) Filed: Aug. 29, 2003

(51) Int. Cl. G02F 1/1335

(52) U.S. Cl. 362/561

(57) ABSTRACT

A direct-light illuminating backlight unit for LCD module has two elongated lamps, each of which is bent into a substantial S-shape having three straight portions and two connection portions connected with the neighboring straight portions respectively. The lamps are mounted side by side on a frame with the straight portions of the lamps are substantially parallel to each other and interval pitches between the straight portions are substantially equal to each other. Such arrangement of the backlight unit is applied to LCD modules with nominal sizes ranged from 12 inches to 17 inches and more preferably applied to modules of, in name, 14 inches or 15 inches.

### BACKGROUND OF THE INVENTION

1. Field of the Invention

The present invention relates generally to a liquid crystal display (LCD) module, and more particularly to a direct-light illuminating unit for the LCD module.

2. Description of the Related Art

Liquid crystal displays (LCDs) have been applied to computer monitors, video devices, consumer electronics and the like. A conventional LCD module is mainly composed of a liquid crystal panel and an illuminating backlight unit. The backlight unit provides illumination to the liquid crystal panel so that the panel can show predetermined images.

A conventional backlight unit is typically classified into so called direct-light illuminating unit and so called edge-light illuminating unit. Typically, the direct-light illuminating unit is composed of at least a lamp and a diffuser (diffusive screen) mounted on a frame and the lamp is arranged behind the diffuser. The edge-light illuminating unit is composed of at least a lamp, a light guild plate and a diffusive film on top of the light guild plate and the lamp is arranged aside the light guild plate, align with an edge thereof.

FIG. 1 shows a conventional direct-light illuminating unit 50 having a plurality of straight lamps as shown in U.S. Pat. No. 5,504,545. FIG. 2 shows U.S. Pat. No. 4,748,546 in which a direct-light illuminating unit 60 has U-shaped lamps 62. Each U-shaped lamp 62 has two straight portions 64 and a connection portion 66 that is connected with ends of the straight portions 64. FIG. 3 shows a conventional direct-light illuminating unit 50 having a winding lamp 72. The winding lamp 72 is made from a straight lamped bent a number of times so that it has a plurality of straight portion 74 and connection portion 76 connected with the ends of neighboring straight portions 74.

For LCD modules of 14″ or 15″, in name of its nominal diagonal size of the viewing area, to achieve an average luminance of 350 cd/m² would typically require six straight lamps 52 for the backlight unit as shown in FIG. 1, three U-shaped lamps 62 for the backlight unit as similarly shown in FIG. 2, or a winding lamp 72 with at least six straight portion 72 for the backlight unit as shown in FIG. 3.

It has to be mentioned that, except for single-lamp backlight unit, the lamps in a backlight unit have better to be in even numbers to cancel or reduce electromagnetic interference noises generated among the lamps. The lamps mentioned here are typically cold cathode fluorescent lamps (CCFL).

Typically, a lamp has to be powered by AC output from a transformer of an inverter (not shown in FIGs.). Hence, six transformers or transformer output channels are needed for an inverter driving a backlight unit with six straight lamps 52; three are needed for an inverter driving a backlight unit with three U-shaped lamps 62; while only one is needed for an inverter driving a backlight unit with a winding lamp 72.

Since the U-lamp configuration shown in FIG. 2 requires fewer transformers or transformer output channels than the straight-lamp configuration shown in FIG. 1, the LCD module uses the U-lamps illuminating unit 60 has a cost advantage over the LCD module uses the straight-lamps illuminating unit 50. Seemingly, the winding-lamp illuminating unit 70 needs only one transformer output to operate would have the best cost advantage for LCD module. However, the winding-lamp has the longest length, which requests a higher operation voltage. When the lamp exceeds a certain length, the surplus cost associated with the much higher operation voltage would surpass the cost saving of reducing the required number of transformers or transformer output channels.

Thus, there is no affirmative designation as to the number of lamps and the shape and the length of lamps of a backlight unit for LCD modules.

### SUMMARY OF THE INVENTION

The primary objective of the present invention is to provide a direct-light illuminating unit (backlight unit) for LCD module. The illuminating unit has a definitive designation to the numbers of lamps and the shape and the length of lamps to meet the typical luminance specifications of most LCD monitors in the market.

According to the objective of the present invention, a direct-light illuminating unit comprises a frame and two elongated lamps, wherein each of the lamps is bent into a substantial S-shape having three straight portions and two connection portions connected with ends of the neighboring straight portions. The S-shaped lamps are firmly mounted side by side on the frame and the straight portions are substantially parallel to each other and interval pitches between the straight portions are substantially equal to each other.

### BRIEF DESCRIPTION OF THE DRAWINGS

FIG. 1 is a top view of the first type of the conventional direct-light illuminating backlight unit;

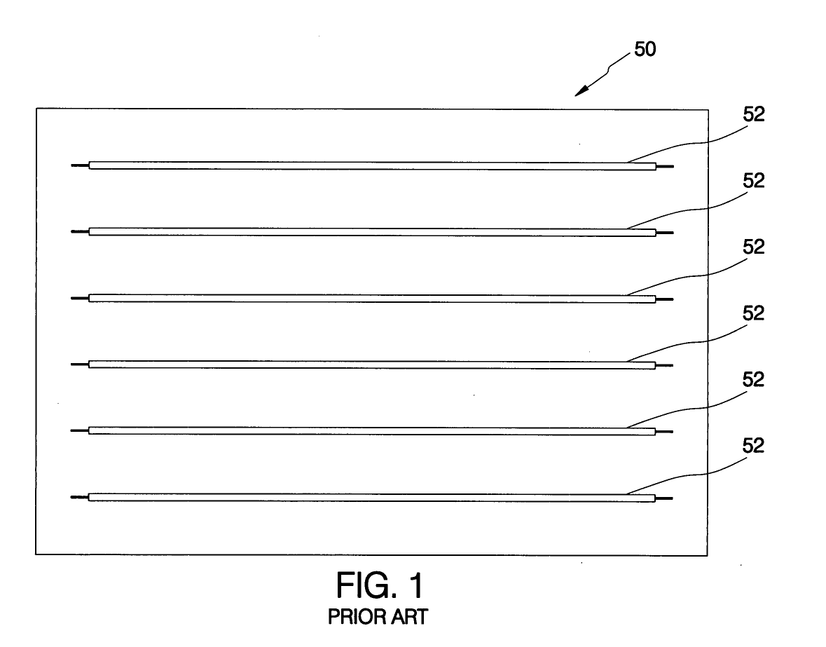

FIG. 2 is a top view of the second type of the conventional direct-light illuminating backlight unit;

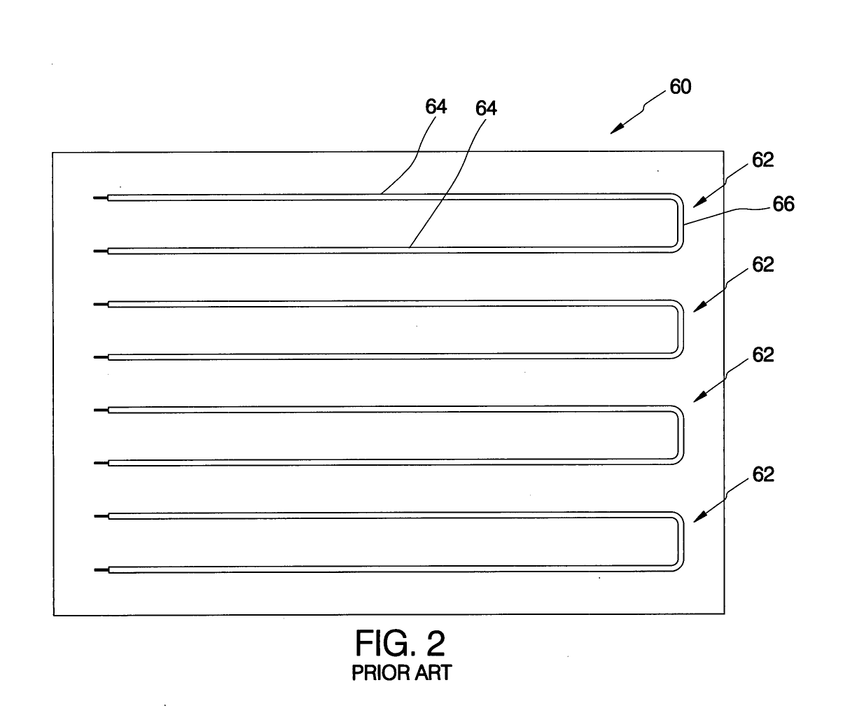

FIG. 3 is a top view of the third type of the conventional direct-light illuminating backlight unit;

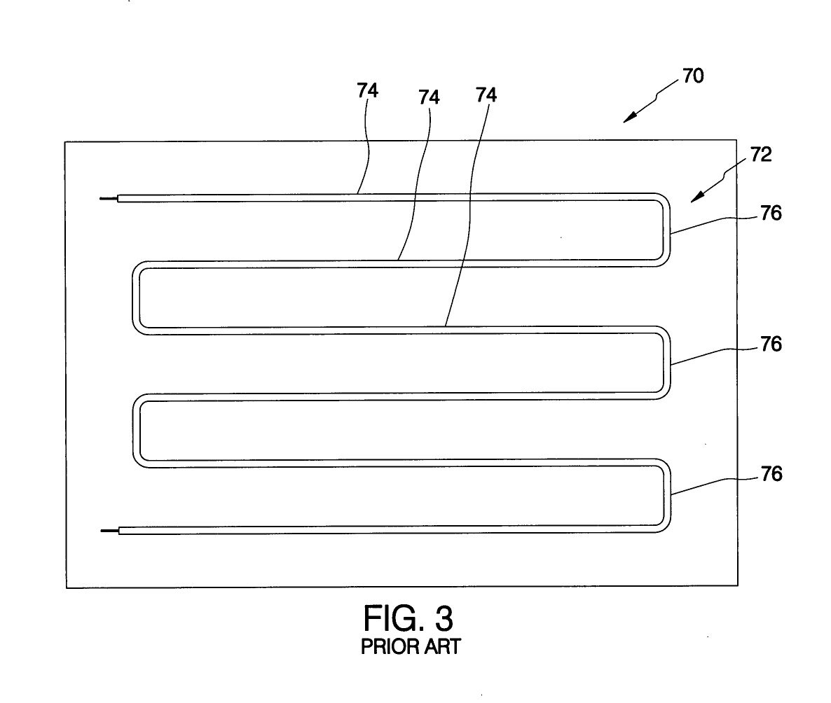

FIG. 4 is a top view in part of a first preferred embodiment of the present invention, and

FIG. 5 is a top view in part of a second preferred embodiment of the present invention.

### DETAILED DESCRIPTION OF THE INVENTION

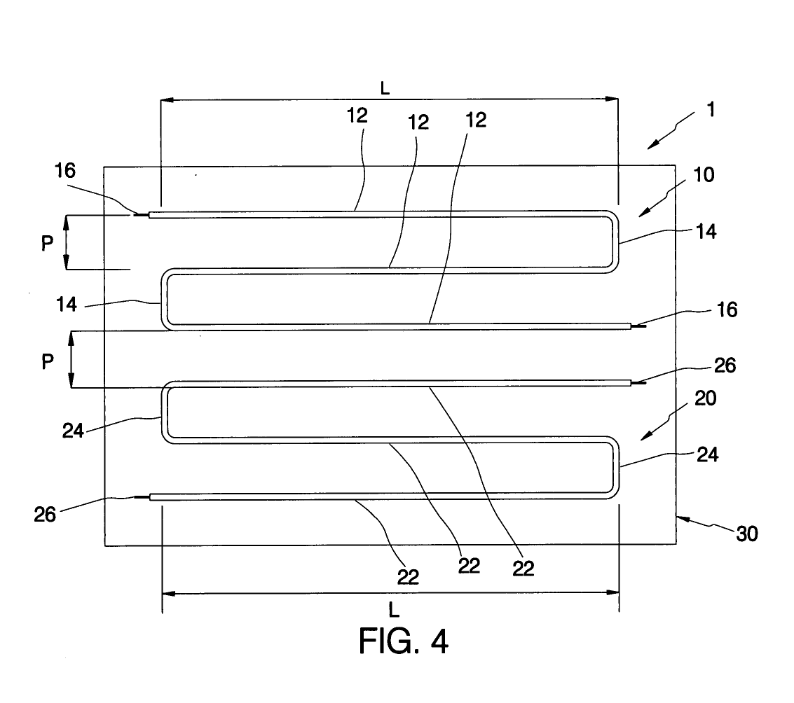

As shown in FIG. 4, the first preferred embodiment of the present invention provides a direct-light illuminating backlight unit 1 for a LCD module, which mainly comprises two lamps 10 and 20 and a frame 30, wherein

The lamps 10 and 20 are Cold Cathode Fluorescent Lamps (CCFLs). Such lamps have advantages of smaller diameter, longer life and higher illuminating performance and so on.

Each lamp 10 and 20 is bent from a straight tube of lamp into a substantial S-shape and each S-shaped lamp 10 and 20 has three straight portions 12 and 22 and two connection portions 14 and 24 connected with ends of each neighboring straight portions 12 and 22. The straight portions 12 and 22 of the S-shaped lamps 10 and 20 are substantially parallel to each other. The S-shaped lamp 10 and 20 has an electrode 16 and 26 at each end thereof respectively. Two transformers or transformer output channels of an inverter (not shown), which is mounted on the frame 30, should be connected to the electrodes 16 and 26 to provide the lamps 10 and 20 with high-voltage AC electricity.

The S-shaped lamps 10 and 20 are mounted side by side on the frame 30, wherein the straight portions 12 and 22 are substantially parallel to each other and the interval pitches P of the straight portions 12 and 22 are substantially equal to each other, too.

As an example of the first preferred embodiment of the current invention, the backlight unit 1 is made into a 15″ LCD module. The diameter of the lamps 10 and 20 is 4 mm. The length of each lamp 10 and 20 is about 1006 mm. A length L of each straight portion 12 and 22 is about 305 mm. Furthermore, the interval pitch P between the straight portions 12 and 22 is about 33.5 mm. The inverter provides AC electricity with a power spectrum of inverse voltage to lamps 10 and 20 respectively, to cancel or reduce electromagnetic interference noises. In addition, a diffuser plate (not shown) of typically 50% to 60% light transmittance is mounted on the frame 30, in front of the lamps 10 and 20. Without additional brightness enhancement films or components, the backlight unit 1 of the aforementioned configuration has a typical luminance in a range between 2000 cd/m² and 5000 cd/m². The LCD module that applies the backlight unit 1 of the present invention would have a typical luminance in a range between 180 cd/m² and 450 cd/m².

The aforementioned backlight unit 1 of present invention can be powered by a single inverter (not shown) with two transformers or a transformer with two output channels connected to lamps 10 and 20. The lamps 10 and 20 have such a length and design that an operation voltage provided by an inverter does not exceed 1200 volts. Therefore, no excess design other than those would normally be done for an inverter of a conventional backlight unit is needed, hence cost saving.

The backlight unit 1 of the present invention can be applied to LCD modules with nominal size of the viewing area ranged from 12 inches to 17 inches. The length of each lamp 10 and 20 is in a range between 780 mm and 1200 mm, the length L of each straight portion 12 and 22 is in a range between 230 mm and 390 mm, and the interval pitch P of the straight portions 12 and 22 is in a range between 25 mm and 45 nm. A combination of optional components, such as, diffuser plate or films and brightness enhancement films, etc., could be mounted on the frame as a screen in front of the lamps. The backlight unit 1 of the aforementioned configuration has a typical luminance in a range between 2000 Cd/m² and 8500 Cd/m², depending on the driving current provided by the inverter and the optional brightness enhancement components which could be used. The LCD module that applies the backlight unit 1 of the present invention would have a typical luminance in a range between 180 cd/m² and 700 cd/m².

The backlight unit 1 of the present invention is preferably applied to LCD modules with the nominal viewing area size of 14 inches or 15 inches. The length of each lamp 10 and 20 is in a range between 910 mm and 1080 mm, the length L of each straight portion 12 and 22 is in a range between 270 mm and 350 mm, and the interval pitch P between the neighboring straight portions 12 and 22 is in a range between 28 mm and 42 mm. The backlight unit 1 of the aforementioned configuration has a typical luminance in a range between 2000 cd/m² and 8500 cd/m², depending on the driving current provided by the inverter and the optional brightness enhancement components which could be used. The LCD) module that applies the backlight unit 1 of the present invention would have a typical luminance in a range between 180 cd/m² and 700 cd/m². With a diffuser screen of typically 50% to 60% light transmittance mounted in front of the lamps and no additional brightness enhancement components applied, the backlight unit 1 of the aforementioned configuration could have a typical luminarce in a range between 2000 cd/m² and 5000 cd/m², depending on the driving electrical current provided by the inverter. The LCD module that applies this later configuration of the backlight unit 1 would have a typical luminance in a range between 180 cd/m² and 450 cd/m², depending on the driving current provided by the inverter.

The advantages of the present invention are hereunder:
1. Only two transformers or transformer output channels are required on the inverter that powers the illuminating unit 1 of the present invention. Moreover, the operation voltage for lamps 10 and 20 is similar to the operation voltage of the conventional illuminating unit with straight lamps or U-shaped lamps. Thus, the inverter for powering the illuminating unit 1 of the present invention can be of the same type design as those for the conventional illuminating units.
2. The cost for two S-lamps is lower than the cost of three U-lamps or six straight-lamps. While, two S-lamps still provide sufficient luminance to LCD modules with nominal size ranged from 12 inches to 17 inches (more preferably to LCD modules with nominal size of 14 inches or 15 inches).
3. The structure of the illuminating unit 1 of the present invention is very simple. In addition, the lamps 10 and 20 are mounted symmetrically, that the electromagnetic interference generated by lamps is canceled or reduced.

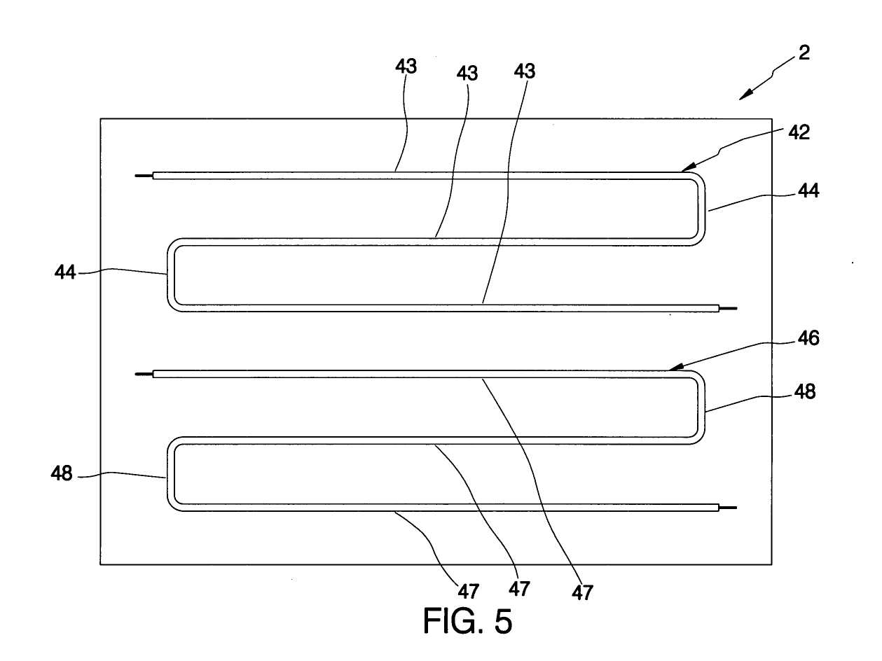

FIG. 5 shows an illuminating unit 2 of the second preferred embodiment of the present invention, which comprises two substantially S-shaped lamps 42 and 46, each of which has three straight portions 43 and 47 and two connection portions 44 and 48. The illuminating unit 2 of the second preferred embodiment is similar to the illuminating unit 1 of the first preferred embodiment, except that the S-shaped lamps 10 and 20 of the first preferred embodiment are being placed side by side in a symmetrical mirror image fashion, while the S-shaped lamps 42 and 46 of the second preferred embodiment are being placed side by side in a parallel replica fashion.

1. A direct light illuminating unit of a LCD module, comprising two elongated lamps, each of which is bent into a substantial S-shape having three straight portions and two connection portions connected with the neighboring straight portions respectively, wherein the lamps are mounted side by side on a frame with the straight portions of the lamps being substantially parallel to each other and interval pitches between the straight portions are substantially equal to each other.

2. The illuminating unit as defined in claim 1, wherein lengths of the lamps are in a range between 780 mm and 1200 mm, while lengths of the straight portions are in a range between 230 mm and 390 mm and the interval pitch between the straight portions is in a range between 25 mm to 45 mm, so that the illuminating unit is being applied to a LCD module with nominal size of viewing area in a range from 12 inches to 17 inches and the illuminating unit as defined herein, hence, has a typical luminance in a range between 2000 cd/m² and 8500 cd/m².

3. The illuminating unit as defined in claim 1, wherein lengths of the lamps are preferably in a range between 910 mm and 1080 mm, while lengths of the straight portions are preferably in a range between 270 mm and 350 mm, and the interval pitch between the straight portions are preferably in a range between 28 mm to 42 mm, so that the illuminating unit is preferably applied to LCD modules of 14 inches or 15 inches, in name of its nominal diagonal size of the viewing area and the illuminating unit as defined herein, hence, has a typical luminance in a range between 2000 cd/m² and 8500 cd/m².

4. The illuminating unit as defined in claim 3, wherein a diffuser screen of typically 50% to 60% light transmittance is mounted in front of the lamps and no additional brightness enhancement components are being used, hence, has a typical luminance in a range between 2000 cd/m² and 5000 cd/m², depending on an operation current provided to the lamps.

5. The illuminating unit as defined in claim 1, wherein the lamps are being placed side by side in a symmetrical mirror image fashion.

6. The illuminating unit as defined in claim 1, wherein the lamps are being placed side by side in a parallel replica fashion.

7. The illuminating unit as defined in claim 1, wherein the lamps are being powered by an inverter which provides each lamp with AC electricity that is in-phase but inverse in voltage, respectively.
